(19) United States
(12) Patent Application Publication
(10) Pub. No.: US 2025/0284248 A1
(43) Pub. Date: Sep. 11, 2025

(54) HOLDOVER OF ATOMIC CLOCKS USING PREDICTIVE TECHNIQUES

(71) Applicant: ColdQuanta, Inc., Boulder, CO (US)

(72) Inventors: Robert James Fasano, Boulder, CO (US); Teague Tomesh, Boulder, CO (US); Ronald Shane Fazzio, Denver, CO (US)

(21) Appl. No.: 19/073,441

(22) Filed: Mar. 7, 2025

Related U.S. Application Data
(60) Provisional application No. 63/562,520, filed on Mar. 7, 2024.

(51) Int. Cl. G04F 5/14

(52) U.S. Cl. CPC G04F 5/14

(57) ABSTRACT

An apparatus for maintaining accurate timekeeping in an atomic clock during holdover is presented. The apparatus comprises data acquisition circuitry configured to store historical clock data; and receive environment data. The apparatus comprises processing circuitry configured with a predictive algorithm, the predictive algorithm configured to analyze a combination of historical clock data, environment data, and real-time clock data; and estimate a future drift in a frequency of the atomic clock at a future time point based on analysis of the combination of historical clock data, environment data, and real-time clock data. The apparatus further comprises control circuitry configured to adjust the frequency of the atomic clock based on the estimated future drift of the frequency of the atomic clock.

### CLAIM OF PRIORITY AND CROSS-REFERENCE TO RELATED APPLICATIONS

This patent application claims the benefit of priority of U.S. Provisional Patent Application Ser. No. 63/562,520, filed Mar. 7, 2024 entitled IMPROVED HOLDER OF ATOMIC CLOCKS USING FEED-FORWARD CONTROL WITH PREDICTIVE ALGORITHMS, which is hereby incorporated by reference in its entirety.

### BACKGROUND

Holdover in the context of atomic clocks refers to the clock's ability to maintain accurate timekeeping in the absence of an ongoing external time reference signal. Holdover is important in applications where uninterrupted access to an external time reference cannot be guaranteed, such as in remote locations or during signal outages. Improvements to holdover capabilities increase the reliability of atomic clocks for precise timekeeping.

### BRIEF DESCRIPTION OF THE DRAWINGS

Various embodiments are disclosed in the following detailed description and the accompanying drawings.

FIG. 1 is a system diagram illustrating an example of portions of a comparator system for detecting interference in a timing signal and providing an alternate timing signal.

FIG. 2 is a block diagram illustrating an example of integration of clock data and ambient data with a prediction model to achieve a drift-compensated state.

FIG. 3 is a flowchart illustrating an example of portions of a process for applying steering corrections to the atomic clock during holdover, according to some examples.

### DETAILED DESCRIPTION

Atomic clocks operate based on oscillations of atoms between certain energy levels, such as cesium or rubidium. To compensate for accumulated timing error from noise in the atomic clock, periodic adjustments and corrections are provided from an external time reference, which can be provided by satellite signals in the case of Global Navigation Satellite Systems (GNSS), e.g., Global Positioning System (GPS), or other precise timekeeping references.

When an atomic clock loses a connection with the external time reference, the atomic clock enters holdover mode. During holdover, the atomic clock continues to generate timekeeping signals using an internal oscillator that maintains the atomic clock's timekeeping capabilities for a certain duration. The holdover period is a parameter that reflects a clock's characteristic ability to retain accuracy without external corrections. Holdover is influenced by factors such as stability of the internal clock oscillator, precision of the initial synchronization (setting two or more clocks to the same time), initial syntonization (setting two or more oscillators to the same frequency), environment conditions that may affect the internal oscillator, etc.

A clock in holdover mode can use a prediction model to predict a future state of the atomic clock, to determine that the future state has drifted from the nominal time or frequency, and to produce an adjustment or correction in the place of the unavailable external time reference. Multiple techniques can be available to predict a future state of an atomic clock system—namely the future values of one or more parameters that characterize the system. These can include algorithms such as Kalman filters and machine learning algorithms such as recurrent neural networks. A technique combining an algorithm to predict the future state of the system with clock data can help improve holdover mode in an atomic clock.

When the external reference signal is available, the prediction model can be continuously calibrated and trained (e.g., can have one or more internal prediction model parameters updated) using the external signal. The calibration of the prediction model can involve comparing a measured clock frequency (e.g., that is locked to a reference frequency) with a predicted frequency that is output by the model. The external clock can provide a reference frequency that can allow the system to adjust and refine one or more parameters of the prediction model.

The atomic clock can use the prediction model to maintain accurate timekeeping when the external reference signal is lost. The prediction model can stop updating (e.g., exit a training mode) and can be used to predict a drift-compensated state (e.g., operate in inference mode, in a machine learning context). The use of a prediction model as an “external reference” can help contribute to accurate timekeeping by the clock even without the external reference signal, such as where the clock employs the previously trained prediction model to predict and correct for any drift in the clock's frequency output during holdover.

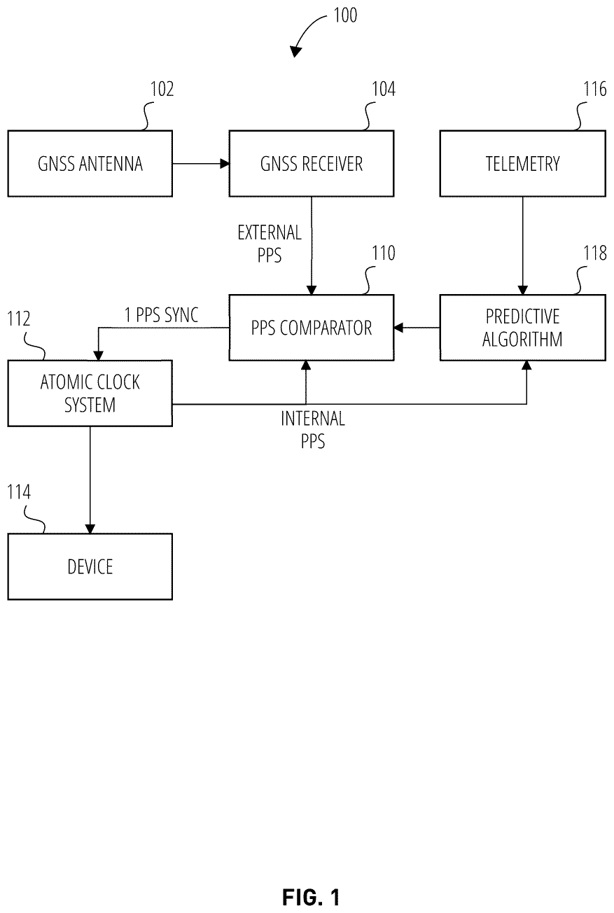

FIG. 1 illustrates a system diagram of an example of portions of a comparator system 100 for maintaining accurate timekeeping in an atomic clock during holdover. The comparator system 100 may include or be coupled to a GNSS antenna 102, a GNSS receiver 104, a pulse-per-second (PPS) (or other pulse-per-time) comparator 110, an atomic clock system 112, a clock-signal-receiving device 114, a telemetry system 116, and a predictive model or algorithm 118.

In an example of operating the comparator system 100, the PPS comparator 110 receives respective 1 PPS (pulse-per-second or other pulse-per-time) timing signals from the GNSS receiver 104 (“external PPS”) and the atomic clock system 112 (“internal PPS”). For devices (e.g., device 114) that employ timing signals or frequency reference(s) to operate (e.g., navigation devices, autonomous vehicles, etc.), the GNSS signal may be considered more ‘trustworthy’ (e.g., stable) over long time periods such as hours and days. Timing signals from atomic clock systems may have a higher precision during shorter time periods, and may experience various environment factors that may cause frequency drifts in the longer term.

During an initial synchronization (sync) period, atomic clock system 112 may steer the internal PPS signal (or other internal pulse-per-time signal generated by atomic clock system 112) to match the external PPS signal (or other external pulse-per-time signal derived from the GNSS receiver 104). Atomic clock system 112 may be any suitable atomic clock, such as a chip scale atomic clock, optical atomic clock (e.g., using a frequency comb to down-convert an optical reference signal to a radio frequency or other electrical reference signal), any suitable atomic clock that uses an energy transition (either microwave or optical) in an atomic vapor, trapped ions, or neutral atoms.

The PPS comparator 110 may produce any suitable comparison signal. For example, the PPS comparator 110 may compare timing of the atomic clock system 112 against a threshold (e.g., “Is atomic clock system 112 within a specified threshold time period, e.g., 10 ns of the external clock signal” ?). In another example, the PPS comparator 110 may track differences between respective clock systems and may determine one or more statistical trends in one or more of the differences (e.g. “Has one clock suddenly started drifting relative to the other in a statistically anomalous way?”).

The telemetry system 116 may collect and transmit data related to the clock's performance, environment conditions, or both. The telemetry system 116 may interface with various sensors and data acquisition systems within the atomic clock system 112 such as to acquire or gather real-time information on one or more parameters such as temperature, pressure, or one or more other environment factors that may influence the clock's accuracy. This data may be used by the predictive algorithm 118 as inputs to a model within the predictive algorithm 118. The telemetry system 116 may provide accurate and up-to-date information for the predictive algorithm 118 to make precise adjustments to the clock's frequency to maintain accuracy during holdover periods.

The predictive algorithm 118 may include any suitable computational tool (e.g., Kalman estimator, machine learning model, neural network, etc.) that may analyze data provided by the telemetry system 116 and other sources (e.g., at least one of current clock state, historical clock states, or any combination thereof) to predict one or more future states of the atomic clock system 112. The predictive algorithm 118 may include advanced machine learning techniques, such as recurrent neural networks, to model the clock's behavior and estimate potential drifts in the clock's frequency, particularly during holdover periods when external reference signals (e.g., external PPS) are unavailable. The predictive algorithm 118 may output a predicted PPS signal, for example when the GNSS receiver 104 is unavailable. The predicted PPS signal may be used at PPS comparator 110 in place of the external PPS signal received from GNSS receiver 104.

For example, predictive algorithm 118 may output the predicted PPS signal to the PPS comparator 110 when the GNSS receiver 104 is available, e.g., to compare the predicted PPS signal to the external PPS reference signal. The predictive algorithm 118 may refine one or more internal parameters with an output from the PPS comparator 110.

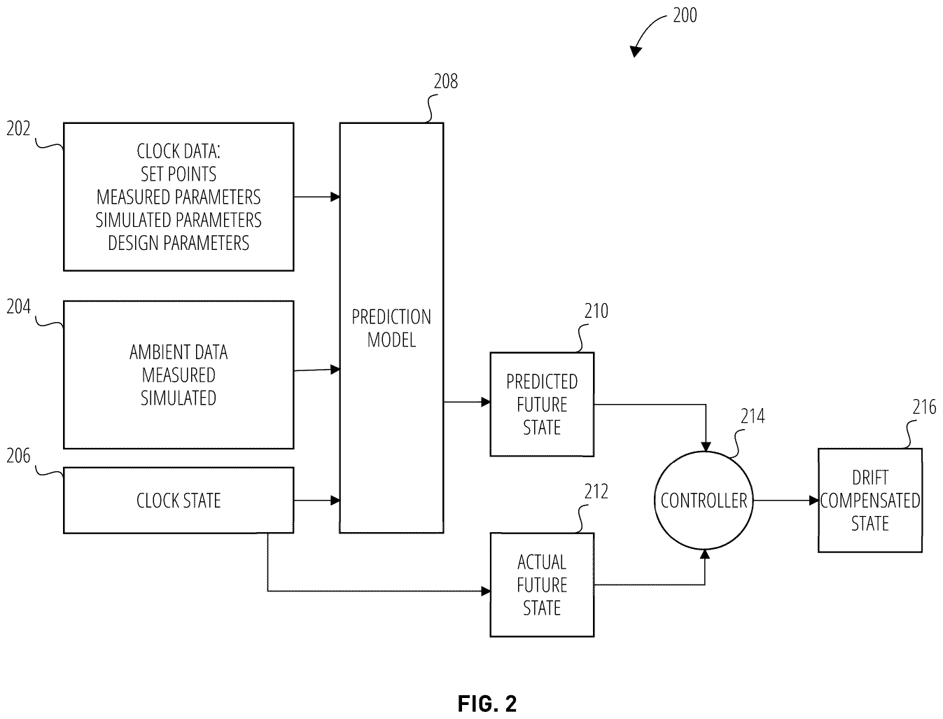

FIG. 2 illustrates an example of portions of a system 200 to combine clock and ambient data in a predictive model for drift compensation of an atomic clock. The system 200 can include a clock data 202 input, an ambient data 204 input, clock state 206 input, which are received at prediction model 208. The system 200 can combine the predicted future state 210 and actual future state 212 at a control mechanism such as using processing circuitry included in controller 214, which can produce drift compensated state 216 output. The clock state adjustment may be implemented using any suitable mechanism, such as by tuning an output frequency of the atomic clock using one or more parameters such as phase-locked loop reference frequencies for the optical frequency comb, laser intensity, or vapor cell temperature.

In an example, clock data 202 may include any suitable set points or other parameters for an operating state of a clock, such as an optical atomic clock. Set points and measured parameters may include (but are not limited to) items such as: temperature of the vapor cell, frequency (e.g., optical frequency) and intensity of the clock laser oscillator, noise measurements and noise predictions in electronic and optoelectronic components, (e.g., phase noise, shot noise, thermal noise, etc.), and measurements of atomic fluorescence. Simulated parameters may include application of measured or modeled time constants to transform input features, e.g. to estimate internal temperature of a component based on external temperature and a known propagation delay. Simulated parameters may also include empirical characterizations of generally nonlinear relationships between controlled parameters, e.g. the impact of ambient temperature on a laser's frequency modulation sensitivity. Physical configuration parameters may include material, size, and thickness of vapor cell walls, etc.

In an example, ambient data 204 may include one or more measurements of temperature (e.g., internal to the clock), pressure (e.g., atmospheric pressure, partial pressure of a gas such as helium), magnetic field(s), and any other suitable ambient measurements. In an example, ambient data 204 may include one or more simulated measurements such as may be output from physics-based modeling (e.g., simulations of atomic and molecular collisions or feature transformation from external to internal contaminant pressures based on known permeation time constants of a glass cell) of the atomic clock system.

In an example, clock state 206 may include an internal PPS signal that may be input to the prediction model 208.

In an example, prediction model 208 may be trained to compensate for one or more mechanisms that may cause the clock state to drift. For example, prediction model 208 may be used to compensate for one or more of nonlinearity in laser current modulation (e.g., in the atomic clock system 112), for residual magnetic fields (e.g., produced by vapor heater cells), for vapor cell opacity change, and for permeation of helium through vapor cell walls, among other physical mechanisms.

Prediction model 208 may compensate for nonlinearity in laser current modulation and variation in modulation sensitivity due to changing housing temperature. As ambient temperature changes, a given current change of the laser (driven by the feedback loop that stabilizes the laser to the atomic transition) may produce a slightly different modulation response. This may cause a shift in clock frequency. Such a shift may be calibrated and may be corrected by prediction model 208 when the clock data 202 includes operating current and temperature of the laser, and the clock data 202 along with the ambient data 204 may be provided as inputs to the prediction model 208. In an example, drift compensated state 216 may correspond to a frequency steering correction.

Prediction model 208 may compensate for residual magnetic fields produced by vapor cell heaters due to changing housing temperature. As ambient temperature changes, heaters (e.g., in atomic clock system 112) attached to the vapor cell are adjusted, which may change the magnetic field experienced by the atoms. This change in magnetic field may be mitigated by appropriate shielding and heater driver design, and a small residual effect may be compensated by the model. In an example, the clock data 202 may include the duty cycle of the vapor cell heaters along with the ambient data 204 (e.g., ambient temperature) and the drift compensated state 216 may correspond to a frequency steering correction.

Prediction model 208 may compensate for vapor cell opacity change. As the vapor cell (e.g., of atomic clock system 112) ages, there is an interaction between the vapor and the glass windows, which gradually darkens the cell, reducing light transmission. This produces a change in the intensity of the light for the atoms in the vapor cell. This can be compensated by monitoring the ratio of laser power to emitted fluorescence output from the vapor cell and, based thereupon, applying a correction. In an example, the clock data 202 may include the incident laser power and a measurement value of the emitted fluorescence and the drift compensated state 216 may correspond to a frequency steering correction.

Prediction model 208 may compensate for the permeation of helium through the vapor cell walls. As helium permeates into the vapor cell, collisional effects between helium and rubidium (or other atomic vapor in the atomic clock) can cause broadening and systematic shifts to the atomic transition, both of which degrade the long-term frequency stability. In an example, the prediction model 208 may include empirical modeling and may be trained on a corpus of data or other training dataset that includes a time series of the local ambient pressure. The local ambient pressure may be recorded by a sensor, e.g. to form ambient data 204. The local ambient pressure may be processed, e.g., with a low-pass filter having a time constant (e.g., informed by prior studies, calculated analytically based on the cell geometry, or left as a free parameter in the model). During holdover (e.g., inference mode of an RNN) the clock data 202 may include local atmospheric pressure variation, and the drift compensated state 216 may correspond to a frequency steering correction.

Prediction model 208 may be used to detect anomalies in an external reference signal. When the external reference signal is available, the prediction model 208 may be in a training mode. When the external reference signal has been used to train the prediction model, e.g., to model the drift of the local clock (e.g., atomic clock system 112), and is still available, the prediction model may be used to assess statistical differences between the reference signal (e.g., external PPS from GNSS receiver 104 in FIG. 1) and the model of the local clock. Sudden disagreements between the model and the reference signal may indicate that the external reference has been compromised, e.g., through GPS jamming or spoofing, and the local clock (e.g., atomic clock system 112) may in response then be switched into holdover mode to maintain timing integrity, and may use the predictive algorithm 118 as the reference.

Prediction model 208 may be trained using electronic componentry in the clock (e.g., in atomic clock system 112). In an example, prediction model 208 may be trained using an external processor and the prediction model 208 (e.g., one or more parameters arrived at during training) can be transferred (e.g., through a firmware update, etc.) to the atomic clock system 112. Prediction model 208 may use electronic componentry in the clock (e.g., in atomic clock system 112) to output the predicted future state 210 (e.g., in an inference mode). In an example, prediction model 208 may use external processors to arrive at the predicted future state 210. That is, in some examples, inferences made by prediction model 208 can be performed external to the clock and can be communicated to the clock (e.g., to the controller 214, to the PPS comparator 110).

In an example, the predicted future state 210 may comprise a value of the clock frequency (e.g., after being perturbed by environment mechanisms) at a future time value. In an example, the predicted future state 210 may include a confidence interval on the value of the clock frequency at the future time value. In an example, the prediction model 208 may comprise a Gaussian process regression that may output an uncertainty with the predicted future state 210.

In an example, the predicted future state 210 may comprise variables such as frequency drift (e.g., mathematical derivative of the clock frequency over a selected time window). In an example, predicted future state 210 may comprise a future value of any input training variables at a time resolution equal to the time resolution present in the training data. In an example, prediction model 208 may output the predicted future state 210 out to arbitrary time periods in the future by feeding the predicted future state 210 back into the prediction model 208 as an input value.

Prediction model 208 may use any suitable predictive algorithm(s). In an example, one or more machine learning algorithms used for predictive analytics with time-series types of data may be used in prediction model 208. Recurrent neural networks (RNNs) are a class of artificial neural networks configured to recognize patterns in sequences of data, making them particularly suitable for time-series analysis and prediction tasks. RNNs have connections that form directed cycles, allowing an RNN to maintain a form of memory by using an internal state to process sequences of inputs. This architecture enables RNNs to capture temporal dependencies and correlations in data, which may be used for predicting future states based on historical data. In the context of atomic clocks, RNNs can be employed to model and predict frequency drift by analyzing sequences of historical clock data and environment parameters. By training on these sequences, RNNs can learn to anticipate changes in clock behavior, providing insights for maintaining accurate timekeeping during holdover periods when external reference signals are unavailable.

Additional types of RNNs that can perform predictive time series analysis include neural networks such as LSTM (Long Short-Term Memory), Gated Recurrent Unit (GRU), and Reservoir Computer (RC) models. Such examples are variants of Recurrent Neural Network (RNN) models which have additional features from a base RNN architecture. For example, LSTM networks may support memory persistence such as context windows of any suitable size or length. In an example, the memory persistence may support an initial factory calibration that may also incorporate environment data acquired during use of the clock. In an example, inductive bias in the RNN (e.g., LSTM) may retain information presented to the RNN across several steps, and may incorporate the retained information to a prediction at a future step in order to increase prediction accuracy.

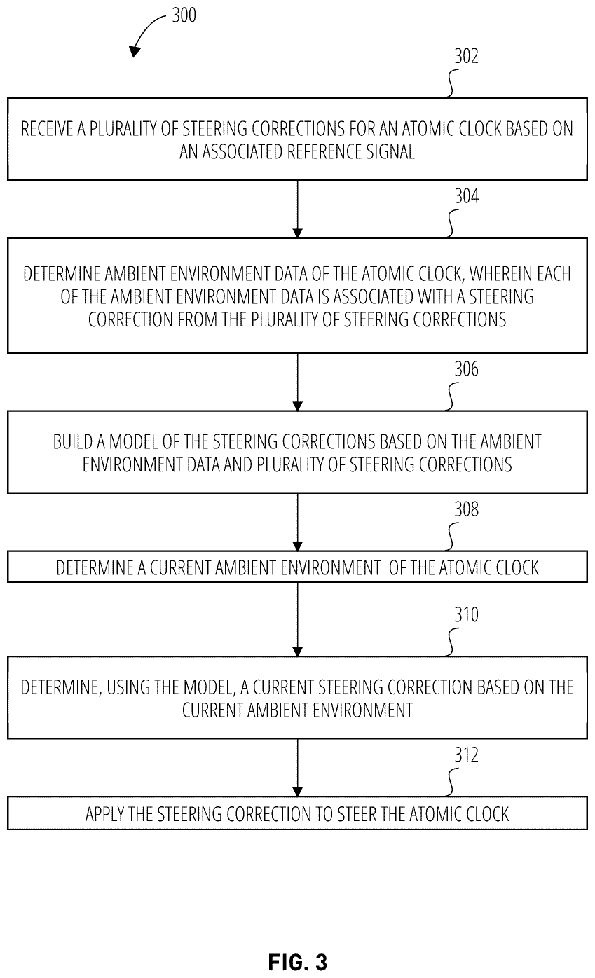

FIG. 3 is a flowchart illustrating an example of portions of process for receiving steering corrections, determining ambient environment data, and applying a model to steer the atomic clock. The flowchart illustrates portions of a method identified as method 300, which comprises a series of operations denoted by reference numbers. While the various operations in this flowchart are presented and described sequentially, one of ordinary skill will appreciate that some or all of the operations may be executed in a different order, be combined or omitted, or be executed in parallel.

At operation 302, the method 300 begins with receiving a plurality of steering corrections for an atomic clock based on an associated reference signal. This operation involves collecting data on adjustments made to the atomic clock's frequency to align it with an external time reference, such as a GNSS signal. This data can include one or more historical corrections applied over a specified time period. In an example, the operation includes using stored data.

From operation 302, the method flows to operation 304, where the method 300 determines ambient environment data of the atomic clock. This operation involves measuring environment parameters such as temperature and pressure, which are associated with each steering correction. In some examples, sensors within the atomic clock housing capture this data. The environment data can be sources of frequency drift when the atomic clock does not receive periodic adjustments to align it with the external time reference. In addition to temperature and pressure, operation 304 may involve measuring or otherwise acquiring internal parameters for the overall clock operating environment, such as nonlinearities in a laser drive current, residual magnetic fields, and aging of componentry in the atomic clock (e.g., vapor cell opacity for outgoing atomic fluorescence changing due to aging).

Following operation 304, the method flows to operation 306, which involves building a model of the steering corrections based on the environment data measured at operation 304 and the plurality of steering corrections received at operation 302. This operation utilizes machine learning algorithms, such as recurrent neural networks, to analyze the collected data and develop a predictive model. In some examples, the model is trained to estimate future frequency drift by considering both historical and real-time data inputs.

From operation 306, the method 300 proceeds to operation 308, where the method 300 determines a current ambient environment of the atomic clock. This operation involves assessing the present operating conditions, such as temperature and pressure, laser setpoints, heater currents, etc., to provide context for the model's predictions. In some examples, this data is continuously updated to reflect changes in the clock's operating environment.

From operation 308, the method 300 proceeds to operation 310, where the method 300 determines, using the model built at operation 304, a current steering correction based on the current ambient environment determined at operation 306. This operation involves applying the predictive model to estimate the necessary adjustments to the atomic clock's frequency to maintain accuracy. In some examples, the model outputs a drift-compensated clock state that guides the clock's frequency adjustments.

From operation 310, the method 300 flows to operation 312, where the method 300 applies the steering correction to steer the atomic clock. This operation involves implementing the model's output to adjust the clock's frequency, ensuring that it remains accurate even in the absence of an external reference signal. In an example, the method 300 determines a frequency adjustment to the atomic clock based on the drift-compensated clock state output by the predictive model. In some examples, the frequency adjustment is applied using feed-forward control mechanisms that modify the reference frequency on a frequency comb system. In an example, the steering correction is applied when the atomic clock is in holdover mode, that is, the atomic clock is not receiving updates from the external reference signal. In this example, when the atomic clock is receiving updates from the external reference, the method 300 can store a record of the drift-compensated clock state for future use in operations 302 and 304 of the method.

From operation 310, the method 300 can flow to operation 302, where the method 300 can perform another iteration. In an example, the method 300 can iterate continuously or at fixed time intervals.

Throughout the method 300, the sequence and decision-making process are guided by the data collected and analyzed at each operation. The transitions between operations are designed to ensure that the atomic clock's frequency is continuously monitored and adjusted based on both historical and real-time environment data.

Method 300 may be machine or computer-implemented at least in part. Some examples may include a computer-readable medium or machine-readable medium encoded with instructions operable to configure an electronic device to perform method 300 as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 is an apparatus for maintaining accurate timekeeping in an atomic clock during holdover, the apparatus comprising: data acquisition circuitry configured to: store historical clock data; and receive environment data; processing circuitry configured with a predictive algorithm, the predictive algorithm configured to: analyze a combination of historical clock data, environment data, and real-time clock data; and estimate a future drift in a frequency of the atomic clock at a future time point based on analysis of the combination of historical clock data, environment data, and real-time clock data; and control circuitry configured to: adjust the frequency of the atomic clock based on the estimated future drift of the frequency of the atomic clock.

In Example 2, the subject matter of Example 1 includes, wherein the predictive algorithm comprises a recurrent neural network.

In Example 3, the subject matter of Examples 1-2 includes, wherein the data acquisition circuitry includes sensors configured to measure ambient temperature and pressure inside a housing of the atomic clock and wherein the environment data comprises at least one of a laser drive current, a heater current, and atomic fluorescence.

In Example 4, the subject matter of Examples 1-3 includes, wherein the control circuitry comprises feed-forward circuitry that applies steering corrections to steer the frequency of the atomic clock based on the estimated future drift of the frequency.

In Example 5, the subject matter of Example 4 includes, wherein the steering corrections comprise adjusting a reference frequency on a frequency comb system of the atomic clock.

In Example 6, the subject matter of Examples 1-5 includes, wherein the predictive algorithm is trained on a corpus of data comprising historical measurements of frequency drift in the atomic clock and simulated measurements of frequency drift.

In Example 7, the subject matter of Examples 1-6 includes, wherein the data acquisition circuitry is further configured to acquire external timing signals, and wherein the predictive algorithm analyzes at least one of: the historical clock data, the real-time clock data, the external timing signals, or any combination thereof.

In Example 8, the subject matter of Example 7 includes, wherein the predictive algorithm is further configured to, when the atomic clock is not in holdover mode, train on at least one of the historical clock data, the real-time clock data, the external timing signals, or any combination thereof to refine estimation parameters of the predictive algorithm.

In Example 9, the subject matter of Examples 1-8 includes, wherein the predictive algorithm is further configured with empirical modeling to estimate future frequency drift due to helium permeation in a housing of the atomic clock.

Example 10 is a method for maintaining accurate timekeeping in an atomic clock during holdover, the method comprising: receiving, by data acquisition circuitry, historical clock data and environment data, including ambient temperature and pressure; analyzing, by processing circuitry configured with a predictive algorithm, a combination of the historical clock data, environment data, and real-time clock data; estimating, by the processing circuitry configured with the predictive algorithm, a future drift in a frequency of the atomic clock at a future time point based on analyzing the combination of the historical clock data, environment data, and real-time clock data; determining, by the processing circuitry, a steering correction based on the estimated future drift; and applying, by control circuitry, the steering correction to adjust the frequency of the atomic clock.

In Example 11, the subject matter of Example 10 includes, wherein the predictive algorithm comprises a recurrent neural network.

In Example 12, the subject matter of Examples 10-11 includes, wherein the data acquisition circuitry includes sensors configured to measure ambient temperature and pressure inside a housing of the atomic clock and wherein the environment data comprises at least one of a laser drive current, a heater current, and atomic fluorescence.

In Example 13, the subject matter of Examples 10-12 includes, wherein the control circuitry comprises feed-forward circuitry that applies steering corrections to steer the frequency of the atomic clock based on the estimated future drift of the frequency.

In Example 14, the subject matter of Example 13 includes, wherein the steering corrections comprise adjusting a reference frequency on a frequency comb system of the atomic clock.

In Example 15, the subject matter of Examples 10-14 includes, wherein the predictive algorithm is trained on a corpus of data comprising historical measurements of frequency drift in the atomic clock and simulated measurements of frequency drift.

In Example 16, the subject matter of Examples 10-15 includes, wherein the data acquisition circuitry is further configured to acquire external timing signals, and wherein the predictive algorithm analyzes at least one of: the historical clock data, the real-time clock data, the external timing signals, or any combination thereof.

In Example 17, the subject matter of Example 16 includes, wherein the predictive algorithm is further configured to, when the atomic clock is not in holdover mode, train on at least one of the historical clock data, the real-time clock data, the external timing signals, or any combination thereof to refine estimation parameters of the predictive algorithm.

In Example 18, the subject matter of Examples 10-17 includes, wherein the predictive algorithm is further configured with empirical modeling to estimate future frequency drift due to helium permeation in a housing of the atomic clock.

Example 19 is a non-transitory machine-readable medium, storing instructions for maintaining accurate timekeeping in an atomic clock during holdover, the instructions, which when executed, cause the medium to perform operations comprising: measuring ambient temperature and pressure inside a housing of the atomic clock and receiving internal data comprising at least one of laser drive current, a heater current, and atomic fluorescence; receiving historical clock data and environment data, including the measured ambient temperature and pressure; analyzing a combination of the historical clock data, environment data, and real-time clock data with a recurrent neural network trained on a corpus of data comprising historical measurements of frequency drift in the atomic clock and simulated measurements of frequency drift; estimating, with the recurrent neural network, a future drift in a frequency of the atomic clock at a future time point based on analyzing the combination of the historical clock data and real-time clock data; determining a steering correction based on the estimated future drift; and applying the steering correction to adjust the frequency of the atomic clock by adjusting a reference frequency on a frequency comb system of the atomic clock.

In Example 20, the subject matter of Example 19 includes, wherein the operations further comprise: acquiring external timing signals, wherein the recurrent neural network analyzes at least one of: the historical clock data, environment data, the real-time clock data, the external timing signals, or any combination thereof to refine estimation parameters of the recurrent neural network.

Example 21 is at least one machine-readable medium including instructions that, when executed by processing circuitry, cause the processing circuitry to perform operations to implement of any of Examples 1-20.

Example 22 is a system to implement of any of Examples 1-20.

The present techniques may be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided above along with accompanying figures that illustrate the principles of the disclosure. The techniques are described in connection with such embodiments, but are not limited to any embodiment. The scope of the invention is limited only by the claims. Numerous specific details are set forth in the preceding description in order to provide a thorough understanding of the disclosure. These details are provided for the purpose of example and the techniques may be practiced according to the claims without some or all of these specific details. For the purpose of clarity, technical material that would be understood in the technical fields related to the present disclosure has not been described in detail so that the present disclosure is not unnecessarily obscured.

Although the foregoing embodiments have been described in some detail for purposes of clarity of understanding, the invention is not limited to the details provided. There are many alternative ways of implementing the present techniques. The disclosed embodiments are illustrative and not restrictive.

What is claimed is:

1. An apparatus for maintaining accurate timekeeping in an atomic clock during holdover, the apparatus comprising:
data acquisition circuitry configured to:
store historical clock data; and
receive environment data;
processing circuitry configured with a predictive algorithm, the predictive algorithm configured to:
analyze a combination of historical clock data, environment data, and real-time clock data; and
estimate a future drift in a frequency of the atomic clock at a future time point based on analysis of the combination of historical clock data, environment data, and real-time clock data; and
control circuitry configured to:
adjust the frequency of the atomic clock based on the estimated future drift of the frequency of the atomic clock.

2. The apparatus of claim 1, wherein the predictive algorithm comprises a recurrent neural network.

3. The apparatus of claim 1, wherein the data acquisition circuitry includes sensors configured to measure ambient temperature and pressure inside a housing of the atomic clock, and wherein the environment data comprises at least one of a laser drive current, a heater current, and atomic fluorescence.

4. The apparatus of claim 1, wherein the control circuitry comprises feed-forward circuitry that applies steering corrections to steer the frequency of the atomic clock based on the estimated future drift of the frequency.

5. The apparatus of claim 4, wherein the steering corrections comprise adjusting a reference frequency on a frequency comb system of the atomic clock.

6. The apparatus of claim 1, wherein the predictive algorithm is trained on a corpus of data comprising historical measurements of frequency drift in the atomic clock and simulated measurements of frequency drift.

7. The apparatus of claim 1, wherein the data acquisition circuitry is further configured to acquire external timing signals, and wherein the predictive algorithm analyzes at least one of: the historical clock data, the real-time clock data, the external timing signals, or any combination thereof.

8. The apparatus of claim 7, wherein the predictive algorithm is further configured to, when the atomic clock is not in holdover mode, train on at least one of the historical clock data, the real-time clock data, the external timing signals, or any combination thereof to refine estimation parameters of the predictive algorithm.

9. The apparatus of claim 1, wherein the predictive algorithm is further configured with empirical modeling to estimate future frequency drift due to helium permeation in a housing of the atomic clock.

10. A method for maintaining accurate timekeeping in an atomic clock during holdover, the method comprising:
receiving, by data acquisition circuitry, historical clock data and environment data, including ambient temperature and pressure;
analyzing, by processing circuitry configured with a predictive algorithm, a combination of the historical clock data, environment data, and real-time clock data;
estimating, by the processing circuitry configured with the predictive algorithm, a future drift in a frequency of the atomic clock at a future time point based on analyzing the combination of the historical clock data, environment data, and real-time clock data;
determining, by the processing circuitry, a steering correction based on the estimated future drift; and
applying, by control circuitry, the steering correction to adjust the frequency of the atomic clock.

11. The method of claim 10, wherein the predictive algorithm comprises a recurrent neural network.

12. The method of claim 10, wherein the data acquisition circuitry includes sensors configured to measure ambient temperature and pressure inside a housing of the atomic clock and wherein the environment data comprises at least one of a laser drive current, a heater current, and atomic fluorescence.

13. The method of claim 10, wherein the control circuitry comprises feed-forward circuitry that applies steering corrections to steer the frequency of the atomic clock based on the estimated future drift of the frequency.

14. The method of claim 13, wherein the steering corrections comprise adjusting a reference frequency on a frequency comb system of the atomic clock.

15. The method of claim 10, wherein the predictive algorithm is trained on a corpus of data comprising historical measurements of frequency drift in the atomic clock and simulated measurements of frequency drift.

16. The method of claim 10, wherein the data acquisition circuitry is further configured to acquire external timing signals, and wherein the predictive algorithm analyzes at least one of: the historical clock data, the real-time clock data, the external timing signals, or any combination thereof.

17. The method of claim 16, wherein the predictive algorithm is further configured to, when the atomic clock is not in holdover mode, train on at least one of the historical clock data, the real-time clock data, the external timing signals, or any combination thereof to refine estimation parameters of the predictive algorithm.

18. The method of claim 10, wherein the predictive algorithm is further configured with empirical modeling to estimate future frequency drift due to helium permeation in a housing of the atomic clock.

19. A non-transitory machine-readable medium, storing instructions for maintaining accurate timekeeping in an atomic clock during holdover, the instructions, which when executed, cause the medium to perform operations comprising:
measuring ambient temperature and pressure inside a housing of the atomic clock;
receiving historical clock data and environment data comprising at least one of a laser drive current, a heater current, and atomic fluorescence;
analyzing a combination of the historical clock data, environment data, and real-time clock data comprising ambient temperature and pressure with a recurrent neural network trained on a corpus of data comprising historical measurements of frequency drift in the atomic clock and simulated measurements of frequency drift;
estimating, with the recurrent neural network, a future drift in a frequency of the atomic clock at a future time point based on analyzing the combination of the historical clock data and real-time clock data;
determining a steering correction based on the estimated future drift; and
applying the steering correction to adjust the frequency of the atomic clock by adjusting a reference frequency on a frequency comb system of the atomic clock.

20. The non-transitory machine-readable medium of claim 19, wherein the operations further comprise:
acquiring external timing signals, wherein the recurrent neural network analyzes at least one of: the historical clock data, environment data, the real-time clock data, the external timing signals, or any combination thereof to refine estimation parameters of the recurrent neural network.
